(19) United States
(12) Patent Application Publication
(10) Pub. No.: US 2010/0178638 A1
(43) Pub. Date: Jul. 15, 2010

(54) Method for teaching grammar through a series of steps

(76) Inventor: Rene Galvan Munoz, San Diego, CA (US)

Correspondence Address: ERIC HANSCOM, 7395 PORTAGE WAY, CARLSBAD, CA, 92011, US

(21) Appl. No.: 12/352,573

(22) Filed: Jan. 12, 2009

(51) Int. Cl. G09B 11/00

(52) U.S. Cl. 434/162

(57) ABSTRACT

A method for teaching grammar where each lesson focuses on a different element of grammar id disclosed. These lessons are preferably arranged not by parts of speech, but rather are grouped such that subsequent lessons build on previously learned lessons. Identifying an element of grammar is achieved through a series of steps, whereby if these steps are followed exactly, the element of grammar can easily be identified. At least one of the steps includes a question, where the answer the question is the element of grammar to be identified by the user.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of education, and more specifically toward a method for teaching grammar where each lesson focuses on a different element of grammar. These lessons are preferably arranged not by parts of speech, but rather are grouped such that subsequent lessons build on previously learned lessons. Nonetheless, lessons that do not build on any previous lesson and are completely independent of other lessons are preferably grouped together by parts of speech. Identifying an element of grammar is achieved through a series of steps, whereby if these steps are followed exactly, the element of grammar can easily be identified. At least one of the steps includes a question, where the answer the question is the element of grammar to be identified by the user.

Grammar has often been a difficult subject for many to learn, even those that have strong English skills. Previously, grammar has often been learned by repetitively performing sentence diagrams whereby individuals identify parts of sentences. As a student progresses, he or she goes through more and more complex sentences. Various elements of grammar are all grouped together by subject: nouns with nouns, verbs with verbs, etc. Homework is performed only on the lesson learned that day. However, students can often be confused when trying to learn elements of grammar in this manner. It has been difficult for a student to focus on learning a single element of grammar, either to learn the element of grammar initially, or to review past elements of grammar that have been learned, while continuing to learn new and different elements of grammar.

### SUMMARY OF THE INVENTION

The current invention is a new and novel method of teaching grammar through a series of steps for each element of grammar. Instead of focusing on a sentence, the method focuses on learning the elements of grammar. By exactly following a series of steps, a particular element of grammar can easily be determined. In addition to learning the steps, the steps should be practiced, preferably before going on to learn the next element of grammar. Some elements of grammar require knowing other elements of grammar. In these instances, one of the steps includes identifying and locating another element of grammar. The elements of grammar are preferably learned not by grouping them into types, but by how the elements of grammar can be learned independently group by group. In other words, elements that depend upon known other elements are grouped together. In this fashion, each group of elements can be learned independently. Note that if a user learns multiple different groups, there may be overlap of material as various different elements may be presented in multiple groups.

It is a principal object of the invention to provide a method for teaching grammar that teaches by learning a particular element of grammar at a time.

It is an additional object of the invention to provide a method for teaching grammar that groups together elements of grammar that are not necessarily related, but rather build upon another.

It is another object of the invention to provide a method for teaching grammar that uses a series of steps to determine a particular element of grammar.

It is a further object of this invention to provide a method for teaching grammar that locates a previously learned element of grammar to locate another element of grammar.

It is also an object of this invention to provide a method for teaching grammar that enables students to study and prepare for a test without having any previous knowledge of grammar.

It is an additional object of this invention to provide a method for teaching grammar that enables an individual to help a student study and prepare for a test where neither the individual nor the student has any previous knowledge of grammar.

It is another object of this invention to provide a method for teaching grammar that enables a student to study on their own using only the materials associated with the current method, and without the need of a teacher or other supplemental materials.

It is a further object of this invention to provide a method for teaching grammar that enables a student to refresh what he or she has learned previously in the method.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### DETAILED DESCRIPTION OF THE INVENTION

Grammar can often be a difficult and confusing subject for a student to learn, especially for those students where English is not his or her first language. To help students learn grammar, the current invention provides step-by-step instructions for each element of grammar. It is beneficial to have checklists made available to the user of the method to verify that he or she has learned the material previously presented. This allows the user to go back and review material not fully learned and to prepare the user for future lessons that involve previously learned material. It is preferable if the lessons are built independently and grouped such that a user can start learning any group he or she chooses without learning other independent areas of grammar. Lessons that build on each other are grouped together. However, it is important to note that subject matter from different groups may overlap. This not only makes each group independent for learning, but when multiple groups are learned, it provides for a means of reviewing material already learned. Unlike the prior art, assigned homework should not focus solely on a single subject; instead, homework should simultaneously provide a means for reviewing multiple elements of grammar. This method provides struggling students multiple opportunities to efficiently and effectively learn key elements of grammar, such as nouns, verbs, and prepositions.

One of the key features of the current invention is the series of steps to determine an element of grammar. While background information on the element of grammar is provided, a series of steps must be learned and followed exactly to determine and identify an element of grammar. This can be done for most elements of grammar and provides a quick and efficient means for identifying a requested element of grammar.

By way of example, the following is a single group of lessons, where the group teaches multiple elements of grammar. As the group progresses through the elements, previously learned elements of grammar must be located to determine the requested element of grammar.

The first element of grammar learned in this exemplary group is prepositional phrases and its parts. A preposition is a word that shows how the object of the preposition (a noun or a pronoun) relates to another word in the sentence. For example:

My dog is near the house. “Near” is the preposition.

My dog is in the house. “In” is the preposition.

My dog is on the house. “On” is the preposition.

Notice that in the examples provided, the preposition changes the relationship between the object of the preposition ‘house’ and, in this case, the subject, ‘dog.’

A prepositional phrase is a group of words working together to create a specific idea. A prepositional phrase will start with a preposition and will end with the object of the preposition(s). For example: with (preposition) dogs (object of the preposition)

Before leaning the steps to determine an object of the preposition of a sentence, the 64 common prepositions should be memorized. These include: about, above, according to, across, after, against, along, among, around, aside from, as, at, because of, before, behind, below, beneath, beside, besides, between, beyond, but, by, despite, down, during, except, for, from, in, in back of, in front of, in place of, in spite of, inside, instead of, into, like, near, next to, of, off, on, on account of, onto, out, out of, outside, over, past, since, through, throughout, to, toward, under, underneath, until, unto, up, upon, with, within, and without.

The steps of determining the object of a preposition include 1) locating and underlining the preposition, 2) asking the question: What or whom comes after the preposition? The answer to the question is the object of the preposition. These steps can also be repeated multiple times within a sentence if multiple prepositions are found. For example, consider the sentence: The technicians encoded a program in a car with instructions and rules. First, the preposition is located. In this sentence, the first preposition is “in.” Then, by answering the question, we find that the object of the preposition is “a car.” If there is more then one object of the preposition they will be joined by a conjunction, usually “and” or “or.” Continuing with the example sentence, the next preposition is located: “with.” Then, we answer the question. Since the technicians encoded the car with both instructions and rules, both are objects of the preposition. The prepositional phrase ends with the last object of the preposition. So, the entire prepositional phrase is: with instructions and rules. The prepositional phrase starts with the preposition, ends with the object of the preposition, and includes every word in between the two. Thus, the steps to determine a prepositional phrase include locating the preposition, object of the preposition, and then determining the prepositional phrase. Note that the steps must be followed exactly. As in the example, if there is more than one preposition then the steps must be repeated for each individual preposition. The object of the preposition will always be either a noun or a pronoun.

One's ability to locate prepositional phrases is extremely important to your success in grammar. Being able to identify, and frequently eliminate, prepositional phrases makes locating other parts of speech such as direct objects, indirect objects, predicate nouns, predicate adjectives, and others easier.

After learning the steps necessary to determine prepositions and objects of prepositions, the user of the method should practice determining these elements of grammar. This practice can include: writing the steps to locate prepositional phrases (which by definition include finding prepositions and determining the object(s) of a preposition), locating the prepositions in sentences, determining the objects of prepositions, and determining the entire prepositional phrase.

The next elements of grammar learned in this exemplary group of lessons are nouns and simple subjects. For this lesson, the user will need to know that a noun is a person, place, thing or idea. Further, a common noun does not name anything specifically; it names a general person, place, thing or idea. Unless at the start of the sentence, a common noun is never capitalized. A proper noun names a specific person, place, thing or idea and is always capitalized.

To determine whether or not a noun is a proper noun, the following series of steps can be followed: 1) rewrite the sentence moving the noun away from the beginning; and 2) determining whether the noun would be capitalized. If it would be capitalized, then it is a proper noun. Otherwise, it is a common known.

The words “a, an, the” are modifying nouns. These are special adjectives known as “articles.” Determining articles can be used to locate some of the nouns in a sentence. First, locate an article. Then, answer the question: what follows the article? The answer to the question is a noun.

A simple subject is another way of saying the main noun of the sentence. The steps for determine the simple subject are: 1) eliminating prepositional phrases; 2) locating the verb of the sentence; and 3) answer the question: Who or what follows the verb of the sentence? The answer to the question is the subject of the sentence. However, there may be times were there is no answer to this question. In this instance, the question of step 3) should be replaced with: who or what precedes the verb in the sentence? The answer to this question should be the subject of the sentence. Unless it is the proper name of something or someone, the simple subject is usually only one word.

After learning the steps necessary to determine nouns and simple subjects, the user of the method should practice determining these elements of grammar. This practice can include: locating prepositional phrases, verbs, and nouns, whether common or proper; listing the steps to locate the simple subject; determining the simple subject of various sentences.

The next elements of grammar learned in this exemplary group of lessons are action verbs and linking verbs. The verb tells what the subject of the sentence is doing or helps to link two parts of a sentence. There are three types of verbs: action verbs, linking verbs and helping verbs. Under the category of action verbs, we have two minor categories: physical action and mental action. A physical action verb is something that can be done or seen, such as running, laughing, and flying. A mental action verb is something that happens in the mind and cannot be seen, such as thinking and dreaming.

To determine the action verb of a sentence, the following series of steps can be performed: 1) eliminate prepositional phrases; 2) locate the subject of the sentence; and 3) ask the question: What comes after the subject? The answer to the question is the action verb of the sentence. The prepositional phrase is eliminated because the verb will never be a part of the prepositional phrase.

A linking verb does not show action; instead it connects, or links, the subject before the linking verb to something after the linking verb. Linking verbs can easily be located by simply memorizing a list of linking verbs. Under the category of linking verbs there are two small categories: eight forms of “be” and ten verbs that express condition. The eight forms of be are: is, am, are, was, were, be, been, and being. The ten verbs that express condition are: appear, become, feel, seem, grow, look, remain, smell, sound, and taste. Note that verbs that express condition can be either linking or action verbs depending on the sentence.

To determine whether the verb is a linking or action verb, the following steps can be performed: 1) replacing the verb that expresses condition with one of the following: is, am, or are; and 2) determining whether the sentence still makes sense. If the sentence still makes sense and keeps the same meaning, then it is a linking verb. Otherwise, it is an action verb.

After learning the steps necessary to determine action verbs and linking verbs, the user of the method should practice determining these elements of grammar. This practice can include: listing the steps to locate action verbs; listing the eight forms of “be”; listing the ten verbs that express condition; locating prepositional phrases, nouns, simple subjects, and verbs; and determining whether the verb is an action verb or a linking verb.

The next elements of grammar learned in this exemplary group of lessons are helping verbs and verb phrases. Helping verbs are verbs that help a main verb (the main verb can be either an action verb or a linking verb). They help to establish a more specific tense and provide a more precise meaning to the verb. A verb phrase means that you have at least one helping verb with the main verb of the sentence. The following are not verb phrases: run, talk, and laugh. The following are verb phrases: will run, will have been running, and will be running. The most helping verbs a verb phrase can have are three. The helping verbs will always be before the main verb. Note that the words “not,” “never,” and “neither” are never part of the verb phrase.

The following is a list of helping verbs: is, am, are, was, were, be, been, do, does, did, have, has, had, may, might, can, could, shall, should, will, and would.

To determine the helping verbs of a sentence, the following steps can be performed: 1) eliminate prepositional phrases; 2) locate the main verb of the sentence, 3) look at the word to the immediate left of the main verb to determine the first helping verb, if any, and 4) continuing to the left until all of the helping verbs have been found.

Alternatively, the main verb can be determined by the following series of steps: 1) locating the helping verb or verbs of the sentence, and 2) answer the question: What follows the helping verb or verbs? The answer to the question is the main verb.

The main verb usually immediately follows the helping verb or verbs. There are, however, exceptions. Negative words are never part of the verb phrase. The negative words one can encounter are: not, never, and neither. Adverbs are never part of the verb phrase. Most adverbs one will encounter in verb phrases will end in “ly.” A negative word and an adverb can be in a verb phrase, but are never part of the verb phrase. Further, it is possible that there is no answer to the question to determine the main verb. In this unlikely scenario, the last helping verb becomes the main verb thereby creating a linking verb phrase. If the entire sentence does not have any helping verbs, then there is just a verb and there here is no verb phrase. In this situation, look for an action verb or a linking verb instead.

After learning the steps necessary to determine action verbs and linking verbs, the user of the method should practice determining these elements of grammar. This practice can include: listing the series of steps to locate a verb phrase and locating prepositional phrases, nouns, subjects, verb phrases, helping verbs, main verbs, action verbs, and linking verbs.

The next element of grammar learned in this exemplary group of lessons is objects of verbs. Complements are words that work with other parts of speech. In this lesson, they are words that work with action verbs. An action verb is an important part of every sentence. The action verb tells what the subject of the sentence is doing. The direct object receives the action of the verb. The indirect object tells to whom, to what, for whom or for what the action of the verb is being done.

To determine the direct object of a sentence, the following steps can be performed: 1) eliminate prepositional phrases; 2) locate the action verb or phrase of the sentence; and 3) answer the question: who or what follows the action verb or phrase? The answer to the question is the direct object.

In order to find the indirect object, you must always find the direct object first. To determine the indirect object of a sentence, the following series of steps can be performed: 1) eliminate prepositional phrases; 2) locate the action verb of phrase of the sentence; 3) answer the question: what follows the action verb or phrase? (this is the direct object); and 4) answer the question of who precedes the direct object? The answer to the question of step 4) is the indirect object.

While you can have a direct object without having an indirect object, it is impossible to have an indirect object without having a direct object. The sentences follow the general pattern of: subject—verb—indirect object (if any)—direct object.

After learning the steps necessary to determine action verbs and linking verbs, the user of the method should practice determining these elements of grammar. This practice can include: listing the steps to locate the direct object and listing the steps to locate the indirect object and locating prepositional phrases, nouns, simple subjects, action verbs, direct objects, and indirect objects.

The next element of grammar learned in this exemplary group of lessons is subject complements, which consists of predicate nouns and predicate adjectives. When a noun follows a linking verb and that noun renames the subject, that noun is called a predicate noun. When an adjective follows a linking verb and that adjective modifies the subject of the sentence, that adjective is called a predicate adjective.

Subject complements will always be after the linking verb. There are only two types of subject complements: predicate nouns and predicate adjectives. A sentence will have either a predicate noun or a predicate adjective but never both in the same sentence. Predicate nouns and predicate adjectives will only be in sentences with linking verbs.

To determine the predicate noun and predicate adjective of a sentence, the following series of steps can be performed: 1) eliminate prepositional phrases; 2) locate the linking verb or phrase; 3) answer the question: who, what or how follows the linking verb? The answer to question three is the predicate noun or predicate adjective of the sentence.

After learning the steps necessary to determine predicate nouns and predicate adjectives, the user of the method should practice determining these elements of grammar. This practice can include: listing the steps to locate the predicate noun or predicate adjective and locating prepositional phrases, nouns, simple subjects, linking verbs, and predicate nouns and predicate adjectives.

The above exemplary grouping of lessons shows the new and novel method used to teach grammar. This method can be implemented in book form. In this embodiment, the user of the method reads through the lessons and performs the necessary practice to properly learn grammar. The book can be similar to that of a workbook that includes the information necessary to learn the grammar lessons as well as the information and blank space to practice them. An alternative embodiment implements the method through a computer or computerized network. This allows the user to interactively learn grammar, whereby the information to learn each a grammar lesson is presented to the user. The user then practices what he or she has learned by interacting with the computer. Feedback can also be given to the user depending on whether he or she has correctly or incorrectly identified the element of grammar.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A method for teaching grammar comprising the steps of:
(a) learning a series of steps to determine a first element of grammar;
(b) practicing the series of steps to determine the first element of grammar;
(c) learning a series of steps to determine a second element of grammar; and
(d) practicing the series of steps to determine the second element of grammar;
where the series of steps must be followed exactly, where at least one of the steps includes a question, where the answer to the question is the element of grammar of a sentence.

2. The method of claim 1, further comprising the steps of:
(e) learning a series of steps to determine a third element of grammar; and
(f) practicing the series of steps to determine the third element of grammar.

3. The method of claim 2, further comprising the steps of:
(g) practicing the series of steps to determine the first element of grammar;
(h) learning a series of steps to determine a fourth element of grammar; and
(i) practicing the series of steps to determine the fourth element of grammar.

4. The method of claim 1, where learning the series of steps to determine a first element of grammar comprises memorizing a plurality of words, where one of the series of steps to determine a first element of grammar is locating one of the plurality of words.

5. The method of claim 1, where the series of steps to determine the second element of grammar includes knowing the first element of grammar.

6. The method of claim 1, where learning the series of steps to determine the second element of grammar comprises memorizing a plurality of words, where one of the series of steps of determining the second element of grammar is locating one of the plurality of words.

7. The method of claim 2, where the series of steps to determine the second element of grammar comprises knowing the first element of grammar.

8. The method of claim 2, where the series of steps to determine the third element of grammar comprises knowing the first element of grammar.

9. The method of claim 2, where the series of steps to determine the third element of grammar comprises knowing the second element of grammar.

10. The method of claim 2, where the series of steps to determine the third element of grammar comprises knowing the first and second elements of grammar.

11. The method of claim 1, where the series of steps to determine an element of grammar are learned from a book.

12. The method of claim 1, where the series of steps to determine an element of grammar are learned through interacting with a computer.

13. A method for teaching grammar comprising the steps of:
(a) learning a series of steps to determine a element of grammar;
(b) practicing the series of steps to determine the element of grammar;
(c) repeating steps (a) and (b) until at least a plurality of elements of grammar have been learned;
where the series of steps must be followed exactly, where at least one of the steps includes a question, where the answer to the question is the element of grammar of a sentence.

14. The method of claim 1, where learning the series of steps to determine a element of grammar comprises memorizing a plurality of words, where one of the series of steps to determine a element of grammar is locating one of the plurality of words.

15. The method of claim 2, where the series of steps to determine one of the elements of grammar comprises knowing another element of grammar.

16. The method of claim 1, where the series of steps to determine an element of grammar are learned from a book.

17. The method of claim 1, where the series of steps to determine an element of grammar are learned through interacting with a computer.

18. A method for teaching grammar comprising the steps of:
(a) learning a series of steps to determine a first element of grammar;
(b) practicing the series of steps to determine the first element of grammar;
(c) learning a series of steps to determine a second element of grammar; and
(d) practicing the series of steps to determine the second element of grammar;
where the series of steps must be followed exactly, where at least one of the steps includes a question, where the answer to the question is the element of grammar of a sentence, where the series of steps to determine the second element of grammar includes knowing the first element of grammar.

19. The method of claim 1, where the series of steps to determine an element of grammar are learned from a book.

20. The method of claim 1, where the series of steps to determine an element of grammar are learned through interacting with a computer.
